(19) United States
(12) Patent Application Publication
(10) Pub. No.: US 2014/0214875 A1
(43) Pub. Date: Jul. 31, 2014

(54) NODE SEARCH SYSTEM AND METHOD USING PUBLISH-SUBSCRIBE COMMUNICATION MIDDLEWARE

(71) Applicant: Electronics and Telecommunications Research Institute, Daejeon (KR)

(72) Inventors: Hae-Young LEE, Seoul (KR); Jin-Myoung KIM, Daejeon (KR); In-Geol CHUN, Seoul (KR); Won-Tae KIM, Asan (KR)

(73) Assignee: Electronics and Telecommunications Research Institute, Daejeon (KR)

(21) Appl. No.: 14/106,502

(22) Filed: Dec. 13, 2013

(30) Foreign Application Priority Data
Jan. 31, 2013 (KR) 10-2013-0011470

(51) Int. Cl. G06F 17/30

(52) U.S. Cl. CPC G06F 17/30194
USPC 707/758

(57) ABSTRACT

Disclosed herein are a node search apparatus and method. The apparatus includes a communication unit, a node search execution unit, and publish-subscribe communication middleware. The communication unit receives information about a child node of a root node in a node tree and a target node from a task distribution unit. The node search execution unit performs a search for the target node on the child node and the lower nodes of the child node. The publish-subscribe communication middleware publishes information about a visited node, which belongs to the child node and the lower nodes of the child node and which is determined not to correspond to the target node by the node search execution unit, to a global database.

### CROSS REFERENCE TO RELATED APPLICATION

This application claims the benefit of Korean Patent Application No. 10-2013-0011470, filed on Jan. 31, 2013, which is hereby incorporated by reference in its entirety into this application.

### BACKGROUND OF THE INVENTION

1. Technical Field

The present invention relates generally to a node search system and method using publish-subscribe communication middleware and, more particularly, to a node search system and method in which a plurality of node search units, to which search tasks for searching a large-scale node tree or graph for target nodes are allocated, exchange information about visited nodes with each other using publish-subscribe communication middleware, thereby performing efficient distribution searches.

2. Description of the Related Art

In order to overcome many problems related to computer engineering, such as formal verification and static analysis, a common node tree or graph search function is required. Since the scale and complexity of problems that should be handled in computer engineering are recently increasing explosively, it takes a lot of time to overcome the problems using only a node tree or graph search based on single computing, or the problems may not be overcome.

In order to overcome the limitations of the node tree or graph search based on single computing, various schemes for performing a node tree or graph search based on distributed computing have been proposed. Among these schemes, U.S. Pat. No. 7,908,040 entitled “System and Method for Automated Search by Distributed Elements” discloses technology in which, in order to search for data, such as distributed geographical features, a discovery probability based on the characteristics of data to be searched for is calculated and a data search is performed through distributed computing based on the calculated discovery probability. In particular, in the technology disclosed in U.S. Pat. No. 7,908,040, when a plurality of agents searches a data space, they perform a data search on a data space having a high probability that data to be searched for by the plurality of agents will be discovered.

However, conventional distributed computing search schemes, such as that of U.S. Pat. No. 7,908,040, are problematic in that it is difficult to efficiently utilize distributed computing resources because central control is required or many communication expenses are incurred between unit computing resources.

### SUMMARY OF THE INVENTION

Accordingly, the present invention has been made keeping in mind the above problems occurring in the prior art, and an object of the present invention is to provide a distribution type node search system and method that make use of publish-subscribe communication middleware in order to exclude additional external control over a plurality of node search units and reduce communication expenses between the node search units, that is, unit resources, upon dividing a target node search task for a large-scale node tree or graph into a plurality of sub-tasks and performing the divided sub-tasks via the plurality of node search units.

In accordance with an aspect of the present invention, there is provided a node search apparatus, including a communication unit configured to receive information about a child node of a root node in a node tree and a target node from a task distribution unit; a node search execution unit configured to perform a search for the target node on the child node and lower nodes of the child node; and publish-subscribe communication middleware configured to publish information about a visited node, which belongs to the child node and the lower nodes of the child node and which is determined not to correspond to the target node by the node search execution unit, to a global database.

The node search execution unit may subscribe to information about a visited node, published by another node search apparatus, from the global database via the publish-subscribe communication middleware, and may not perform the search for the target node on the visited node published by the other node search apparatus.

The node search apparatus may further include an unvisited node list storage unit configured to store a list of unvisited nodes that belong to the child node and the lower nodes of the child node and that are not searched by the node search execution unit; and the node search execution unit may perform the search for the target nodes on the unvisited nodes included in the list stored in the unvisited node list storage unit.

The node search execution unit may remove the visited node, published by the other node search apparatus, from the list if the visited node published by the other node search apparatus is included in the list stored in the unvisited node list storage unit.

The node search execution unit may remove any one of the unvisited nodes included in the list stored in the unvisited node list storage unit, and may perform the search for the target node on the removed unvisited node.

The node search apparatus may further include a visited node list storage unit configured to store a list of a visited node determined not to correspond to the target node by the node search execution unit, and the visited node published by the other node search apparatus.

The node search execution unit may calculate a child node of the visited node that belongs to the child node and the lower nodes of the child node and that is determined not to correspond to the target node based on the node tree, and may include the calculated child node in the unvisited node list storage unit if the calculated child node is not present in the list stored in the visited node list storage unit.

The node search execution unit may report no target node discovery results to the task distribution unit via the communication unit if there is no unvisited node in the list stored in the unvisited node list storage unit.

The node search execution unit may report target node discovery results to the task distribution unit via the communication unit if the removed unvisited node corresponds to the target node.

In accordance with another aspect of the present invention, there is provided a node search method, including receiving, by a communication unit, information about a child node of a root node in a node tree and a target node from a task distribution unit; including, by a node search execution unit, the child node of the root node in an unvisited node list stored in an unvisited node list storage unit; checking, by the node search execution unit, the unvisited node list; removing, by the node search execution unit, one unvisited node from the unvisited node list if an unvisited node is present in the unvisited node list; performing, by the node search execution unit, a search for the target node on the removed unvisited node; and publishing, by the node search execution unit, information about the removed unvisited node determined not to correspond to the target node to a global database via publish-subscribe communication middleware if the removed unvisited node does not correspond to the target node.

The node search method may further include subscribing, by the node search execution unit, to information about a visited node published by another node search unit from the global database via the publish-subscribe communication middleware.

The node search method may further include including, by the node search execution unit, the visited node published by the other node search unit in a visited node list stored in a visited node list storage unit.

The node search method may further include calculating, by the node search execution unit, a child node of a node determined not to correspond to the target node based on the node tree and including the calculated child node in the unvisited node list if the calculated child node is not present in the visited node list stored in the visited node list storage unit.

The node search method may further include reporting, by the node search execution unit, no target node discovery results to the task distribution unit via the communication unit if there is no unvisited node in the unvisited node list.

The node search method may further include reporting, by the node search execution unit, target node discovery results to the task distribution unit via the communication unit if the removed unvisited node does not correspond to the target node.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram illustrating the configuration of a node search system according to the present invention;

FIG. 2 is a diagram illustrating information or commands that are exchanged between a task distribution unit and node search units in the node search system of FIG. 1 according to the present invention;

FIG. 3 is a diagram illustrating information that is exchanged between the node search unit and a global database in the node search system of FIG. 1 according to the present invention;

FIG. 4 is a block diagram illustrating the configuration and operation of the task distribution unit in the node search system of FIG. 1 according to the present invention;

FIG. 5 is a block diagram illustrating the configuration and operation of the node search unit in the node search system of FIG. 1 according to the present invention; and

FIG. 6 is a flowchart illustrating a node search method according to the present invention.

### DESCRIPTION OF THE PREFERRED EMBODIMENTS

A node search system including a task distribution unit and node search units and a node search method according to embodiments of the present invention will be described with reference to the accompanying drawings below. Prior to the detailed description of the present invention, it should be noted that the terms and words used in the specification and the claims should not be construed as being limited to ordinary meanings or dictionary definitions. Meanwhile, the embodiments described in the specification and the configurations illustrated in the drawings are merely examples and do not exhaustively present the technical spirit of the present invention. Accordingly, it should be appreciated that there may be various equivalents and modifications that can replace the examples at the time at which the present application is filed.

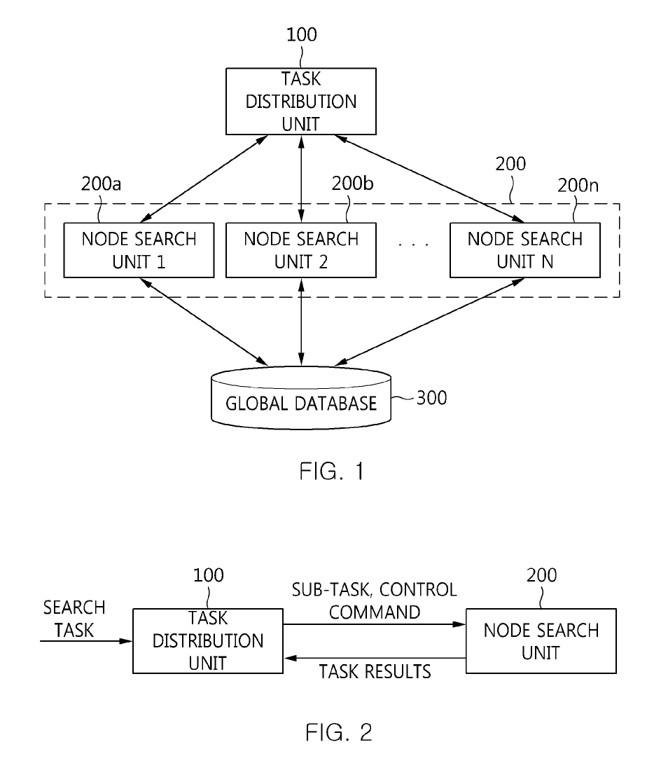

The configuration and operation of a node search system including a task distribution unit and node search units according to the present invention will be described below with reference to FIGS. 1 to 5.

FIG. 1 is a block diagram illustrating the configuration of a node search system according to the present invention.

Referring to FIG. 1, the node search system according to the present invention includes a task distribution unit 100, a plurality of node search units 200a to 200n, and a global database 300.

The task distribution unit 100 is responsible for the distribution of tasks. The task distribution unit 100 receives the root and target nodes of a node tree as a search task, generates the child nodes of the root node and the target nodes as sub-tasks, and transfers the sub-tasks to the respective node search units 200a to 200n. Furthermore, the task distribution unit 100 sends a control command, requesting the plurality of node search units 200a to 200n to start searches for the target nodes with respect to child nodes allocated to the respective node search units 200a to 200n and all lower nodes of the child nodes in the node tree, to all the node search units 200a to 200n. If any one of the plurality of node search units 200a to 200n discovers one of the target nodes, the task distribution unit 100 sends a control command, requesting the node search units 200a to 200n to stop the searches for the target nodes, to all the node search units 200a to 200n.

The plurality of node search units 200a to 200n starts to search the node tree from the child nodes allocated by the task distribution unit 100. Nodes that are determined not to belong to the target nodes in a process in which any one node search unit searches the node tree do not need to be searched by the other search units again. Accordingly, a node search unit that has determined that any one node does not belong to the target nodes publishes information about the corresponding node to the global database 300 via publish-subscribe communication middleware. The other node search units subscribe to the corresponding node, published by the global database 300 and determined not to belong to the target nodes, via the publish-subscribe communication middleware, and thus do not search the corresponding node. If one of the target nodes is discovered in a child node allocated to each node search unit and all lower nodes belonging to the child node or if there is no node to be searched, the node search unit stops the search, and transfers the results of the search to the task distribution unit 100.

FIG. 2 is a diagram illustrating information or commands that are exchanged between the task distribution unit and the node search units in the node search system of FIG. 1 according to the present invention.

In order to avoid redundant descriptions, one node search unit 200 will be described below as an example.

FIG. 2 illustrates an example of exchanging data between the task distribution unit and each node search unit. The task distribution unit 100 receives a search task, including a node tree, information about a root node and information about target nodes to be searched for, from a user or an external system. The task distribution unit 100 extracts the child nodes of the root node using the node tree, distributes the extracted child nodes, and generates sub-tasks including information about the child nodes and the information about the target nodes. Furthermore, the task distribution unit 100 sends a corresponding generated sub-task to the node search unit 200 along with the node tree. Furthermore, the task distribution unit 100 transfers a request to start or stop the search task to the node search unit 200 as a control command. If one of the target nodes is discovered or if there is no node to be searched in the process of searching the allocated child node and lower nodes belonging to the child node for the target nodes in the node tree, the node search unit 200 sends the results of the search (i.e., target node discovery results or no target node discovery results) to the task distribution unit 100 as the results of the search task.

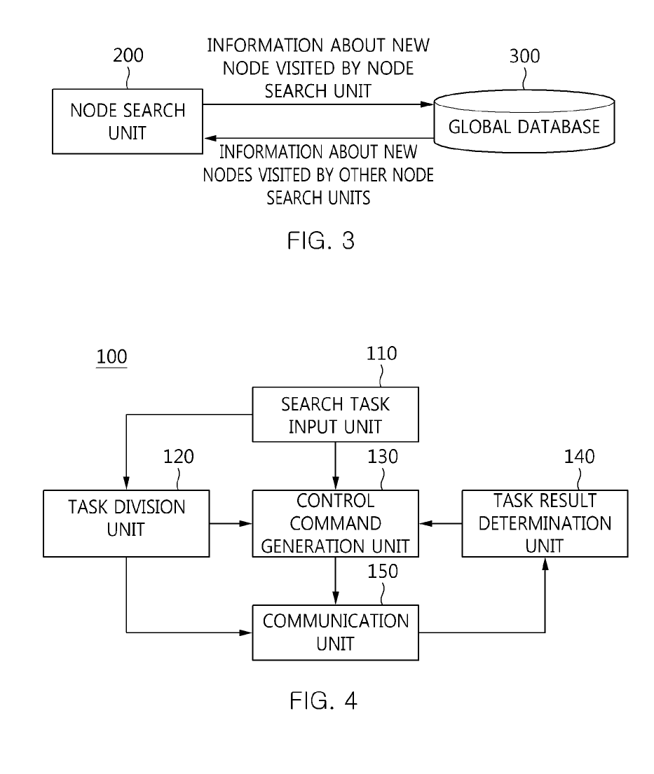

FIG. 3 is a diagram illustrating information that is exchanged between the node search unit 200 and the global database 300 in the node search system of FIG. 1 according to the present invention.

Referring to FIG. 3, the node search unit 200 publishes information about a visited node, determined not to be one of target nodes in the process of searching an allocated child node and lower nodes belonging to the child node for the target nodes in a node tree, to the global database 300 via publish-subscribe communication middleware. Furthermore, the other node search units subscribe to the information about the visited node determined not to be one of the target nodes from the global database 300 via the publish-subscribe communication middleware, and thus do not search the visited node.

FIG. 4 is a block diagram illustrating the configuration and operation of the task distribution unit 100 in the node search system of FIG. 1 according to the present invention.

Referring to FIG. 4, the task distribution unit 100 includes a search task input unit 110, a task division unit 120, a control command generation unit 130, a task result determination unit 140, and a communication unit 150.

The search task input unit 110 receives a search task, including a node tree, information about a root node, and information about target nodes to be searched for, from a user or an external system. The search task input unit 110 transfers the received search task to the task division unit 120.

The task division unit 120 divides the search task into a plurality of sub-tasks by obtaining child nodes from the search task with respect to the root node of the node tree received from the search task input unit 110. In this case, the division of the search task by the task division unit 120 may vary depending on the characteristics of the search task that is given first. The task division unit 120 sends each sub-task, including information about the child node, information about the target nodes, and the node tree, to each node search unit that will search the node tree based on each child node of the root node via the communication unit 150. That is, the task division unit 120 sends the sub-tasks, including information about different child nodes, to the plurality of node search units via the communication unit 150 so that the plurality of node search units searches the node tree based on the different child nodes of the root node.

The control command generation unit 130 generates a control command, requesting all the node search units to start the search task, in response to an instruction from the task division unit 120. Furthermore, the control command generation unit 130 may generate a control command, requesting all the node search units to stop the search task, in response to an instruction from the task result determination unit 140. The control command generation unit 130 sends the generated control command to the node search units via the communication unit 150.

The task result determination unit 140 receives the results of the search task (i.e., target node discovery results or no target node discovery results) from the node search units via the communication unit 150. Furthermore, if the results of the search task received from a node search unit correspond to target node discovery results, the task result determination unit 140 instructs the control command generation unit 130 to generate a control command that requests all the plurality of node search units to stop the search task. If the search task input to the search task input unit 110 corresponds to a task for searching nodes, belonging to the node tree, for all target nodes, the task result determination unit 140 may instruct the control command generation unit 130 to generate a control command, requesting all the plurality of node search units to stop the search task, only when all the target nodes are discovered by the plurality of search units.

The communication unit 150 transfers the sub-tasks, divided by the task division unit 120, to the respective node search units. In this case, the communication unit 150 also transfers the control command, generated from the control command generation unit 130 in order to request the start of the search task, to the node search units along with the sub-tasks. Furthermore, the communication unit 150 may transfer the control command, generated from the control command generation unit 130 in order to request the stop of the search task, to the node search units. Furthermore, the communication unit 150 may receive the results of the search task (i.e., target node discovery results or no target node discovery results) from each of the node search units, and transfer the results of the search task to the task result determination unit 140.

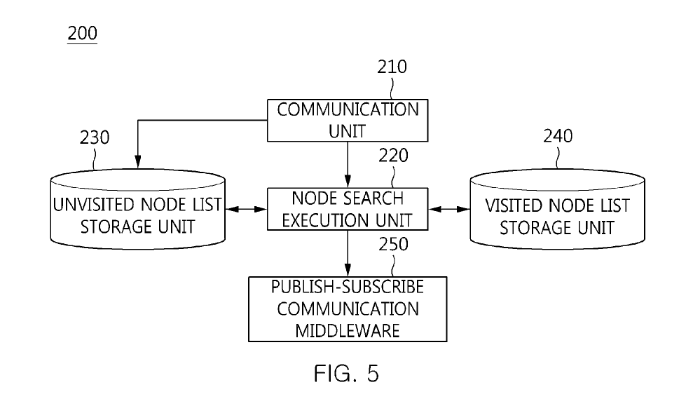

FIG. 5 is a block diagram illustrating the configuration and operation of the node search unit 200 in the node search system of FIG. 1 according to the present invention.

Referring to FIG. 5, the node search unit 200 includes a communication unit 210, a node search execution unit 220, an unvisited node list storage unit 230, a visited node list storage unit 240, and publish-subscribe communication middleware 250.

The communication unit 210 receives a sub-task from the task distribution unit 100. In this case, the sub-task received by the communication unit 210 from the task distribution unit 100 includes information about any one child node of a root node, information about target nodes, and a node tree. The communication unit 210 transfers the information about the child node, included in the sub-task, to the unvisited node list storage unit 230 so that the child node is first registered with an unvisited node list stored in the unvisited node list storage unit 230. Furthermore, the communication unit 210 transfers the information about the target nodes and the node tree to the node search execution unit 220. The communication unit 210 receives a control command, requesting the starting or stopping of a search task, from the task distribution unit 100, and transfers the control command to the node search execution unit 220. Furthermore, the communication unit 210 transfers the results of the search task (i.e., target node discovery results or no target node discovery results), generated from the node search execution unit 220, to the task distribution unit 100.

The node search execution unit 220 searches the child node included in the sub-task and lower nodes belonging to the child node in the node tree for the target nodes. The node search execution unit 220 starts or stops the search for the target nodes in response to a control command received from the task distribution unit 100 via the communication unit 210. The search for the target nodes by the node search execution unit 220 is performed in such a manner that the node search execution unit 220 removes one unvisited node from the unvisited node list stored in the unvisited node list storage unit 230 and searches the removed unvisited node for the target nodes. If any one of the target nodes is discovered or if there is no unvisited node in the unvisited node list stored in the unvisited node list storage unit 230 in the search process, the node search execution unit 220 transfers the results of the search task to the task distribution unit. Furthermore, the node search execution unit 220 publishes information about a node (i.e., visited node), determined not to belong to the target nodes during the search process, to the global database 300 via the publish-subscribe communication middleware 250, and subscribes to information about visited nodes, determined not to belong to the target nodes by other node search units, from the global database 300 via the publish-subscribe communication middleware 250. In this case, the node search execution unit 220 may subscribe to information about visited nodes that satisfy specific conditions in order to reduce communication expenses. The node search execution unit 220 checks whether information about a visited node, published by another node search unit and subscribed from the global database 300, is present in the unvisited node list and removes the visited node from the unvisited node list if, as a result of the check, the information about the visited node published by another node search unit is present in the unvisited node list. Furthermore, the node search execution unit 220 adds information about a visited node, published by another node search unit and subscribed from the global database 300, to the visited node list stored in the visited node list storage unit 240. Meanwhile, if it is determined that an unvisited node included in the unvisited node list does not belong to the target nodes as a result of searching the unvisited node for the target nodes, the node search execution unit 220 calculates the child nodes of the unvisited node based on the node tree, and includes the calculated child nodes in the unvisited node list.

The unvisited node list storage unit 230 stores a list of unvisited nodes on which the node search execution unit 220 has not performed a search for the target nodes, from among the child node included in the sub-task and the lower nodes of the child node. The child node included in the sub-task received via the communication unit 210 is first registered with the unvisited node list stored in the unvisited node list storage unit 230.

The visited node list storage unit 240 stores a list of visited nodes determined not to belong to the target nodes by the node search execution unit 220, and visited nodes published by other node search units.

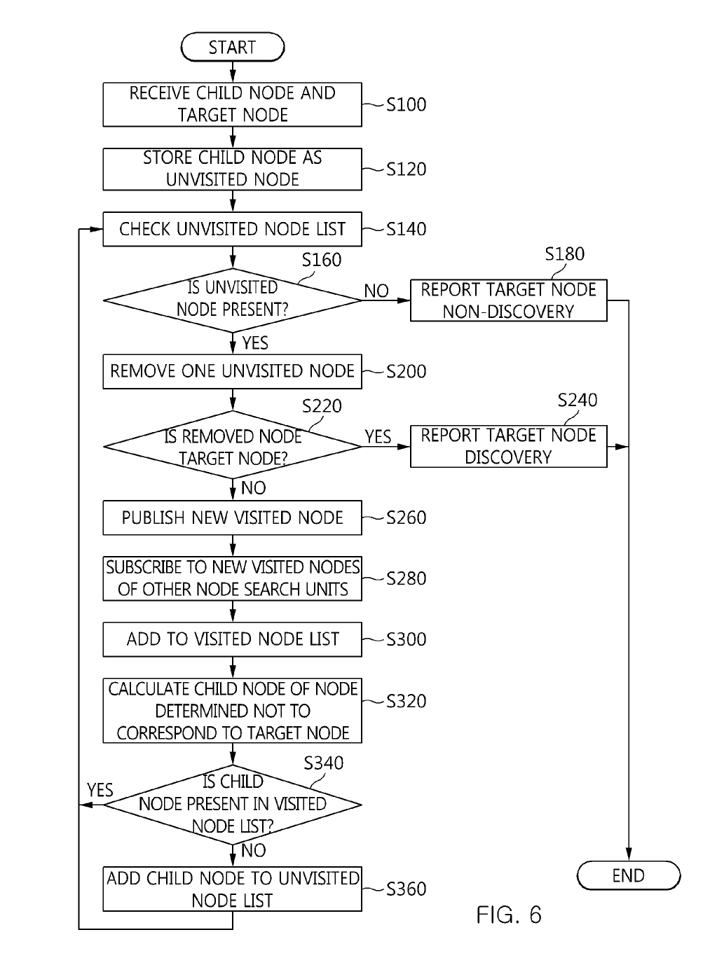

A node search method that is performed by the node search unit of FIG. 1 will be described below with reference to FIG. 6. Descriptions of parts that overlap those of the operation of the node search system given with reference to FIGS. 1 to 5 according to the present invention will be omitted.

FIG. 6 is a flowchart illustrating the node search method according to the present invention.

Referring to FIG. 6, in the node search method according to the present invention, first, the node search unit 200 receives a sub-task, including information about any one child node of a root node in a node tree, information about target nodes, and a node tree, from the task distribution unit 100 via the communication unit 210 at step S100.

Thereafter, the node search unit 200 first registers the child node with an unvisited node list with reference to the sub-task, received from the task distribution unit 100 at step S100, and stores the unvisited node list with which the child node has been registered in the unvisited node list storage unit 230 at step S120.

Thereafter, the node search execution unit 220 of the node search unit 200 determines whether any one unvisited node not searched is present in the unvisited node list at step S160 by checking the unvisited node list stored in the unvisited node list storage unit 230 at step S140.

If, as a result of the determination at step S160, it is determined that any one unvisited node is not present in the unvisited node list, the node search execution unit 220 reports no target node discovery results, informing that the target nodes are not discovered, to the task distribution unit 100 via the communication unit 210 at step S180, and terminates the target node search procedure.

In contrast, if, as a result of the determination at step S160, it is determined that any one unvisited node is present in the unvisited node list, the node search execution unit 220 removes any one unvisited node from the unvisited node list at step S200, and determines whether the unvisited node removed at step S200 corresponds to the target nodes at step S220.

If, as a result of the determination at step S220, it is determined that the unvisited node removed at step S200 corresponds to the target nodes, the node search execution unit 220 reports target node discovery results, informing that the target node has been discovered, to the task distribution unit 100 via the communication unit 210 at step S240, and terminates the target node search procedure.

In contrast, if, as a result of the determination at step S220, it is determined that the unvisited node removed at step S200 does not correspond to the target nodes, the node search execution unit 220 informs other node search units that the unvisited node does not belong to any one of the target nodes. For this purpose, the node search execution unit 220 regards the unvisited node, determined not to correspond to the target nodes at step S220, as its own new visited node and publishes information about the new visited node to the global database 300 via the publish-subscribe communication middleware 250 at step S260.

Furthermore, the node search execution unit 220 subscribes to information about new visited nodes, published by other node search units, from the global database 300 via the publish-subscribe communication middleware 250 at step S280. In this case, the node search execution unit 220 checks whether the new visited nodes published by other node search units are present in the unvisited node list stored in the unvisited node list storage unit 230 and removes a corresponding new visited node from the unvisited node list if, as a result of the check, any one of the new visited nodes published by other node search units is present in the unvisited node list. Accordingly, the node search execution unit 220 does not search the new visited nodes, published by other node search units, for the target nodes.

Although FIG. 6 illustrates that step S280 at which the node search execution unit 220 subscribes to information about the new visited nodes published by other node search units is performed after step S260 of publishing information about its own new visited node, step S280 is not necessarily performed immediately after step S260. For example, step S280 of subscribing to information about the new visited nodes published by other node search units may be performed before step S260 of publishing information about its own new visited node, or step S280 may be performed immediately before step S140 of checking the unvisited node list stored in the unvisited node list storage unit 230.

Thereafter, the node search execution unit 220 adds the unvisited node determined not to correspond to the target nodes at step S220 and the new visited nodes of other node search units subscribed at step S260 to the visited node list stored in the visited node list storage unit 240 at step S300.

Thereafter, the node search execution unit 220 calculates the child nodes of the unvisited node based on the node tree, determined not to correspond to the target nodes at step S220, at step S320.

Thereafter, the node search execution unit 220 determines whether each of the child nodes obtained at step S320 is present in the visited node list stored in the visited node list storage unit 240 at step S340.

If, as a result of the determination at step S340, it is determined that each of the child nodes calculated at step S320 is not present in the visited node list stored in the visited node list storage unit 240, the node search execution unit 220 adds the child node not present in the visited node list to the unvisited node list stored in the unvisited node list storage unit 230 at step S360.

Thereafter, the node search unit 200 returns to step S140 of checking the unvisited node list stored in the unvisited node list storage unit 230. Furthermore, the node search unit 200 repeatedly performs steps S140 to S360 until there is no unvisited node in the unvisited node list, a target node is discovered, a control command requesting the end of the search task is received from the task distribution unit 100, or the search for the target nodes is performed on all lower nodes belonging to the child node of the allocated root node.

As described above, in accordance with the present invention, the plurality of node search units to which search tasks for searching a large-scale node tree or graph for target nodes are allocated exchange information about visited nodes with each other using publish-subscribe communication middleware. Accordingly, there are advantages in that communication expenses between unit computing resources can be reduced, central control can be performed, and target nodes can be efficiently searched for in a large-scale tree or graph via distributed resources.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A node search apparatus, comprising:
a communication unit configured to receive information about a child node of a root node in a node tree and a target node from a task distribution unit;
a node search execution unit configured to perform a search for the target node on the child node and lower nodes of the child node; and
publish-subscribe communication middleware configured to publish information about a visited node, which belongs to the child node and the lower nodes of the child node and which is determined not to correspond to the target node by the node search execution unit, to a global database.

2. The node search apparatus of claim 1, wherein the node search execution unit subscribes to information about a visited node, published by another node search apparatus, from the global database via the publish-subscribe communication middleware, and does not perform the search for the target node on the visited node published by the other node search apparatus.

3. The node search apparatus of claim 2, further comprising an unvisited node list storage unit configured to store a list of unvisited nodes that belong to the child node and the lower nodes of the child node and that are not searched by the node search execution unit;
wherein the node search execution unit performs the search for the target nodes on the unvisited nodes included in the list stored in the unvisited node list storage unit.

4. The node search apparatus of claim 3, wherein the node search execution unit removes the visited node, published by the other node search apparatus, from the list if the visited node published by the other node search apparatus is included in the list stored in the unvisited node list storage unit.

5. The node search apparatus of claim 4, wherein the node search execution unit removes any one of the unvisited nodes included in the list stored in the unvisited node list storage unit, and performs the search for the target node on the removed unvisited node.

6. The node search apparatus of claim 5, further comprising a visited node list storage unit configured to store a list of a visited node determined not to correspond to the target node by the node search execution unit, and the visited node published by the other node search apparatus.

7. The node search apparatus of claim 6, wherein the node search execution unit calculates a child node of the visited node that belongs to the child node and the lower nodes of the child node and that is determined not to correspond to the target node based on the node tree, and includes the calculated child node in the unvisited node list storage unit if the calculated child node is not present in the list stored in the visited node list storage unit.

8. The node search apparatus of claim 7, wherein the node search execution unit reports no target node discovery results to the task distribution unit via the communication unit if there is no unvisited node in the list stored in the unvisited node list storage unit.

9. The node search apparatus of claim 7, wherein the node search execution unit reports target node discovery results to the task distribution unit via the communication unit if the removed unvisited node corresponds to the target node.

10. A node search method, comprising:
receiving, by a communication unit, information about a child node of a root node in a node tree and a target node from a task distribution unit;
including, by a node search execution unit, the child node of the root node in an unvisited node list stored in an unvisited node list storage unit;
checking, by the node search execution unit, the unvisited node list;
removing, by the node search execution unit, one unvisited node from the unvisited node list if an unvisited node is present in the unvisited node list;
performing, by the node search execution unit, a search for the target node on the removed unvisited node; and
publishing, by the node search execution unit, information about the removed unvisited node determined not to correspond to the target node to a global database via publish-subscribe communication middleware if the removed unvisited node does not correspond to the target node.

11. The node search method of claim 10, further comprising subscribing, by the node search execution unit, to information about a visited node published by another node search unit from the global database via the publish-subscribe communication middleware.

12. The node search method of claim 11, further comprising including, by the node search execution unit, the visited node published by the other node search unit in a visited node list stored in a visited node list storage unit.

13. The node search method of claim 12, further comprising calculating, by the node search execution unit, a child node of a node determined not to correspond to the target node based on the node tree and including the calculated child node in the unvisited node list if the calculated child node is not present in the visited node list stored in the visited node list storage unit.

14. The node search method of claim 13, further comprising reporting, by the node search execution unit, no target node discovery results to the task distribution unit via the communication unit if there is no unvisited node in the unvisited node list.

15. The node search method of claim 14, further comprising reporting, by the node search execution unit, target node discovery results to the task distribution unit via the communication unit if the removed unvisited node does not correspond to the target node.
